(19) United States
(12) Patent Application Publication
(10) Pub. No.: US 2009/0106152 A1
(43) Pub. Date: Apr. 23, 2009

(54) MONEY TRANSFERS UTILIZING UNIQUE RECEIVER IDENTIFIER

(75) Inventors: Matt Dill, Atlanta, GA (US); Rebecca Mann, Englewood, CO (US); Paul Blair, Castle Rock, CO (US); Jacques Gilbert, Atherton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 12/146,650

(22) Filed: Jun. 26, 2008

Related U.S. Application Data
(60) Provisional application No. 60/980,675, filed on Oct. 17, 2007.

(51) Int. Cl. G06Q 40/00

(52) U.S. Cl. 705/44; 705/39

(57) ABSTRACT

Methods, systems, and machine-readable media are disclosed for financial transfers utilizing a unique identifier to facility flexible payment options for the transaction. According to one embodiment, a method for supporting a money transfer transaction can comprise receiving a request to initiate the money transfer transaction. The request can include a unique identifier for a recipient of the money transfer transaction. A destination for transferring funds for the money transfer transaction to the recipient can be determined based at least in part on the unique identifier for the recipient. The funds for the money transfer transaction can be transferred to the determined destination and the recipient can be notified of availability of funds at the determined destination.

### CROSS-REFERENCE TO RELATED APPLICATIONS

This application claims priority to Provisional U.S. Patent Application No. 60/980,675 filed Oct. 17, 2007, entitled “MONEY TRANSFERS UTILIZING A UNIQUE RECEIVER IDENTIFIER,” the entire disclosure of which is hereby incorporated by reference for all purposes.

### BACKGROUND OF THE INVENTION

This invention relates generally to financial transfers. More specifically, the invention relates to financial transfers utilizing a unique identifier to facility flexible payment options for the transaction.

Third party money transfer services are used extensively to transfer money and pay bills through the use of wire transfers, money orders, and the like. The use of such services, however, usually requires face-to-face contact between an individual representing the third party service provider and the sender and/or the receiver. For example, if a sender is “wiring” money to a receiver, the money is typically deposited with the third party in person, and the sender typically obtains the money from the third party in person. If the money is transferred in the form of a money order, the sender typically deposits the money with the third party in person and receives a money order.

The use of mobile devices in various types of transactions is also becoming more common. For example, various forms of wireless or mobile device such as cell phone, Personal Digital Assistants (PDAs), etc. can be used to initiate a contactless communication with a Point-Of-Sale (POS) device and pay for goods and services purchased by the user of the device. These devices can also be used to provide other functions with regard to financial accounts to which they may be linked or related. However, money transfer services and systems have not yet been adapted to take advantage of the flexibility and functionality that the use of such mobile devices can provide. Hence, there is a need in the art for improved methods and systems for performing money transfers to facility flexible payment options for the transactions.

### BRIEF SUMMARY OF THE INVENTION

Methods, systems, and machine-readable media are disclosed for financial transfers utilizing a unique identifier to facility flexible payment options for the transaction. According to one embodiment, a method for supporting a money transfer transaction can comprise receiving a request to initiate the money transfer transaction. The request can include a unique identifier for a recipient of the money transfer transaction. A destination for transferring funds for the money transfer transaction to the recipient can be determined based at least in part on the unique identifier for the recipient. The funds for the money transfer transaction can be transferred to the determined destination and the recipient can be notified of availability of funds at the determined destination.

For example, receiving the request to initiate the money transfer transaction can comprise receiving the request from a mobile wallet application, from a web site of a money transfer facilitator, from a retail agent location of a money transfer facilitator, from a telephone money transfer service of a money transfer facilitator, etc. The unique identifier for the recipient of the money transfer transaction can comprise a phone number for a mobile device of the recipient, an email address for the recipient, an instant messaging identifier for the recipient, a preferred customer number for the recipient, etc.

Determining the destination for transferring funds to the recipient can comprise determining a mobile network operator for the recipient and determining whether the mobile network operator for the recipient has a relationship with a money transfer facilitator supporting the money transfer transaction. In response to determining the mobile network operator for the recipient has a relationship with the money transfer facilitator, a determination can be made as to whether the recipient is enrolled in a mobile wallet service of the mobile network operator. The destination for transferring funds for the money transfer transaction to the recipient can comprise an account associated with the mobile wallet service if the recipient is enrolled in the mobile wallet service of the mobile network operator. Alternatively, the destination for transferring funds for the money transfer transaction to the recipient can comprise a destination designate by the recipient if the recipient is not enrolled in the mobile wallet service of the mobile network operator.

According to yet another alternative, in response to determining the recipient is not enrolled in the mobile wallet service of the mobile network operator, a message can be send to the recipient inviting the recipient to enroll in the mobile wallet service. In such a case, the destination for transferring funds for the money transfer transaction to the recipient can comprise an account associated with the mobile wallet service if the recipient enrolls in the mobile wallet service of the mobile network operator. According to still another alternative, the destination for transferring funds for the money transfer transaction to the recipient comprises a destination designated by the recipient if the mobile network operator for the recipient does not have a relationship with the money transfer facilitator.

According to another embodiment, a system can comprise a mobile communications network and a money transfer facilitator system communicatively coupled with the mobile communications network. The money transfer facilitator system can be adapted to receive a request to initiate the money transfer transaction, the request including a unique identifier for a recipient of the money transfer transaction, determine a destination for transferring funds for the money transfer transaction to the recipient based at least in part on the unique identifier for the recipient, affect a transfer of the funds for the money transfer transaction to the determined destination, and notify the recipient of availability of funds at the determined destination. The system can further comprise a mobile network operator system communicatively coupled with the mobile communications network. The money transfer money transfer facilitator, in determining the destination for transferring funds to the recipient can further determine whether the mobile network operator has a relationship with the money transfer facilitator.

The mobile network operator system can be adapted to determining whether the recipient is enrolled in a mobile wallet service of the mobile network operator system. The destination for transferring funds for the money transfer transaction to the recipient can comprise an account associated with the mobile wallet service if the recipient is enrolled in the mobile wallet service of the mobile network operator. Alternatively, the destination for transferring funds for the money transfer transaction to the recipient can comprise a destination designate by the recipient if the recipient is not enrolled in the mobile wallet service of the mobile network operator. According to yet another alternative, in response to determining the recipient is not enrolled in the mobile wallet service of the mobile network operator, a message can be send to the recipient inviting the recipient to enroll in the mobile wallet service. In such a case, the destination for transferring funds for the money transfer transaction to the recipient can comprise an account associated with the mobile wallet service if the recipient enrolls in the mobile wallet service of the mobile network operator. According to still another alternative, the destination for transferring funds for the money transfer transaction to the recipient comprises a destination designated by the recipient if the mobile network operator for the recipient does not have a relationship with the money transfer facilitator.

According to yet another embodiment, a machine-readable medium having stored thereon a series of instructions which, when executed by a processor, causes the processor to support a money transfer transaction by receiving a request to initiate the money transfer transaction, the request including a unique identifier for a recipient of the money transfer transaction, determining a destination for transferring funds for the money transfer transaction to the recipient based at least in part on the unique identifier for the recipient, transferring the funds for the money transfer transaction to the determined destination, and notifying the recipient of availability of funds at the determined destination. Determining the destination for transferring funds to the recipient can comprise determining a mobile network operator for the recipient and determining whether the mobile network operator for the recipient has a relationship with a money transfer facilitator supporting the money transfer transaction.

In response to determining the mobile network operator for the recipient has a relationship with the money transfer facilitator, a determination can be made as to whether the recipient is enrolled in a mobile wallet service of the mobile network operator. The destination for transferring funds for the money transfer transaction to the recipient can comprise an account associated with the mobile wallet service if the recipient is enrolled in the mobile wallet service of the mobile network operator. Alternatively, the destination for transferring funds for the money transfer transaction to the recipient can comprise a destination designate by the recipient if the recipient is not enrolled in the mobile wallet service of the mobile network operator. According to yet another alternative, in response to determining the recipient is not enrolled in the mobile wallet service of the mobile network operator, a message can be send to the recipient inviting the recipient to enroll in the mobile wallet service. In such a case, the destination for transferring funds for the money transfer transaction to the recipient can comprise an account associated with the mobile wallet service if the recipient enrolls in the mobile wallet service of the mobile network operator. According to still another alternative, the destination for transferring funds for the money transfer transaction to the recipient comprises a destination designated by the recipient if the mobile network operator for the recipient does not have a relationship with the money transfer facilitator.

### BRIEF DESCRIPTION OF THE DRAWINGS

FIG. 1 is a block diagram illustrating an exemplary system for making financial transfers according to one embodiment of the present invention.

FIG. 2 is a block diagram illustrating an exemplary computer system upon which embodiments of the present invention may be implemented.

FIG. 3 illustrates an exemplary flow for a “mobile-to-cash” transaction according to one embodiment of the present invention.

FIG. 4 illustrates an exemplary flow for a “cash-to-mobile” transaction according to one embodiment of the present invention.

FIG. 5 illustrates an exemplary flow for a “mobile-to-mobile” transaction according to one embodiment of the present invention.

FIG. 6 illustrates an exemplary flow for a transaction in which the recipient enrolls “in-flight” according to one embodiment of the present invention.

FIG. 7 illustrates an exemplary flow for a transaction in which the recipient elects a “cash pick-up” option according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a machine readable medium. A processor(s) may perform the necessary tasks.

Generally speaking, embodiments of the present invention provide methods and systems for supporting money transfer transactions initiated by and/or conducted through a variety of channels including but not limited to a wireless communication channel including a wireless communication device. Exemplary systems and methods for performing money transfer transactions via a wireless communication device, such as a cellular phone, blackberry, palm pilot, or similar personal communication device are described in co-pending U.S. patent application Ser. No. 11/462,223 filed Aug. 3, 2006 by Blair et al and entitled MONEY TRANSFER TRANSACTIONS VIA PRE-PAID WIRELESS COMMUNICATION DEVICES, the complete disclosure of which is herein incorporated by reference in its entirety for all purposes. However, it should be understood that the description of these methods and systems are offered by way of example only and are not intended to limit the scope of embodiments disclosed herein. Rather, other methods and systems for supporting money transfer transactions may also be used with various embodiments of the present invention.

According to one embodiment, a money transfer transaction can be initiated through a variety of channels. As will be seen, a notification functionality can be provided that uses a unique customer identifier. For example, the unique customer identifier can be provided by the sender to associate the transaction with a receiver's account and/or to notify the receiver of the transaction. The notification can also provide the recipient with the ability to decide on a payout method to receive the money transfer funds. The money transfer transaction may be initiated from a retail agent location of a money transfer facilitator (such as Western Union), from a web site of the money transfer facilitator, from a telephone money transfer service of the money transfer facilitator, from a mobile money transfer send, a kiosk, an ATM or from other channels. In any of the channels, the transaction may be staged by the sender and then completed at a later time. For example, a sender can stage a transaction by calling an IVR or speaking with an operator for the money transfer facilitator to provide transaction information (e.g., sender name, receiver name, and/or amount) and then complete the transfer by visiting an Agent location and paying the transfer amount, along with applicable fees. Similarly, a sender may stage a transaction by paying for it in advance in a checkout lane and then later providing the money transfer facilitator with transaction information (e.g., by providing the transaction information via IVR, live operator and/or web page). The sender can provide the unique identifier for the recipient, which can be any public or proprietary identifier unique to the recipient. For example, the unique identifier for the receiver can be one or any combination of a mobile phone number, an email address, an instant messaging identification, a customer number, account information (e.g., stored value account identifier, bank account number and/or ABA routing number), tax number (e.g., Social Security Number or Taxpayer Identification Number), drivers' license number, state ID number, student ID number or other unique identifier. A customer number can be a preferred customer number or any other unique customer identifier issued by a money transfer facilitator, an agent of money transfer facilitator, a mobile network operator, a retailer, a bank, a service provider (e.g., payment service provider, auction service provider or Internet service provider) or any other party.

Upon receipt of the transfer request, the money transfer facilitator system can reference external and/or internal databases to identify the recipient's mobile network operator and country. The money transfer facilitator system can also determine whether the customer has enrolled in a mobile wallet and corresponding private account for the money transfer funds to be routed to. If this lookup indicates that the recipient is a mobile subscriber for a mobile network operator with whom money transfer facilitator has a relationship and is enrolled in the operator's mobile wallet, the recipient can receive an SMS or other format message notifying them that they have received a money transfer and that funds are available in their mobile wallet associated account. If the lookup indicates that the recipient is not enrolled in a mobile wallet, they can alternatively receive an SMS or other format message notifying them that they have received a mobile money transfer. The message can also ask them to either enroll in a mobile wallet to receive their funds in an associated account, to pick up cash at a retail outlet of the money transfer facilitator and/or to designate a destination for transferring funds (e.g., to bank account, investment account, stored value card or account, prepaid card or account, debit card or account, or at a kiosk or an ATM). If the lookup indicates that the recipient is a mobile subscriber for a mobile network operator with whom the money transfer facilitator does not have a relationship, the recipient can receive a notification via SMS or other format message indicating that funds are available for pickup in cash at a cash retail outlet. Other formats for messages can include, without limitation, electronic mail, instant messaging, live operator call, prerecorded or automated voice message, or web page notification.

Stated another way, a method of supporting a money transfer transaction can comprise receiving a request to initiate the money transfer transaction. Receiving the request to initiate the money transfer transaction can comprise receiving the request from a mobile wallet application of a mobile device, from a web site of a money transfer facilitator, from a retail agent location of a money transfer facilitator, from a telephone money transfer service of a money transfer facilitator, from a kiosk, from an ATM or from another channel. The request can include a unique identifier for a recipient of the money transfer transaction. The unique identifier for the recipient of the money transfer transaction can comprise one or any combination of a phone number for a mobile device of the recipient, an email address for the recipient, an instant messaging identifier for the recipient, a preferred customer number for the recipient or other unique customer identifier issued by a money transfer facilitator or its agent, a mobile network operator, a retailer, a bank, a service provider or any other party, account information (e.g., stored value account identifier, bank account number and/or ABA routing number), a tax number (e.g., Social Security Number or Taxpayer Identification Number), a drivers' license number, a state ID number, a student ID number or another unique identifier.

A destination for transferring funds for the money transfer transaction to the recipient can be determined based at least in part on the unique identifier for the recipient. Determining the destination for transferring funds to the recipient can comprise determining a mobile network operator for the recipient and determining whether the mobile network operator for the recipient has a relationship with a money transfer facilitator supporting the money transfer transaction. If the mobile network operator for the recipient has a relationship with the money transfer facilitator, a determination can be made as to whether the recipient is enrolled in a mobile wallet service of the mobile network operator. If the recipient is enrolled in the mobile wallet service of the mobile network operator, the destination for transferring funds for the money transfer transaction to the recipient comprises an account associated with the mobile wallet service. If the recipient is not enrolled in the mobile wallet service of the mobile network operator, the destination for transferring funds for the money transfer transaction to the recipient can comprise a retail outlet of the money transfer facilitator or other designated destination. Additionally or alternatively, in response to determining the recipient is not enrolled in the mobile wallet service of the mobile network operator, a message can be sent to the recipient inviting the recipient to enroll in the mobile wallet service. If the recipient enrolls in the mobile wallet service of the mobile network operator, the destination for transferring funds for the money transfer transaction to the recipient can comprise an account associated with the mobile wallet service. If the mobile network operator for the recipient does not have a relationship with the money transfer facilitator, the destination for transferring funds for the money transfer transaction to the recipient can comprise a retail outlet of the money transfer facilitator or other designated destination.

Once the destination for transferring funds for the money transfer transaction to the recipient has been determined, the funds can be transferred to the determined destination and the recipient can be notified of availability of funds at the determined destination. Notification can be sent by a money transfer facilitator to the recipient and/or to any party associated with the designated destination (e.g., to a mobile network operator, a retailer, a bank, a service provider (e.g., payment service provider, auction service provider or Internet service provider) or any other party).

Such a system allows a money transfer facilitator, using a unique customer identifier and internal and/or external mapping databases, to provide a structured settlement between unrelated entities such as the sending mobile wallet and receiving mobile wallet, or between the sending cash retail location and receiving mobile wallet. It need not be a closed-loop system that allows mobile remittances only for consumers who are enrolled in the same mobile wallet system but rather allows entities that are unrelated to allow their enrolled consumers to send a mobile money transaction to a consumer either enrolled under another entity or not enrolled - in which case they are able to enroll in a mobile wallet service, pick up cash at a retail location of the money transfer facilitator or other cash retail outlet or designate a destination for receipt of the money transfer.

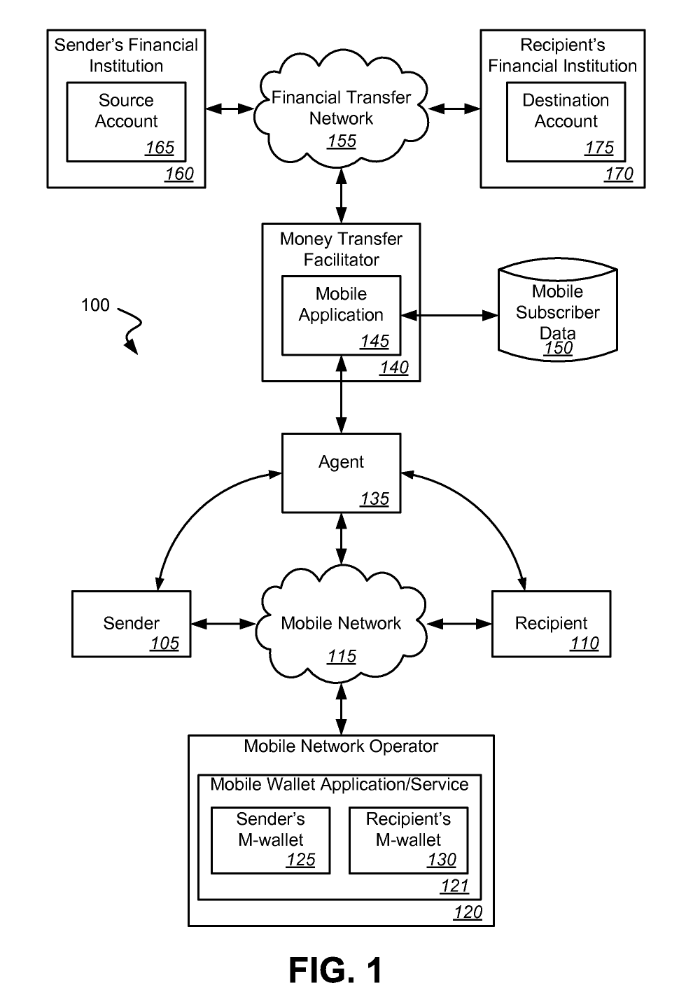

FIG. 1 is a block diagram illustrating an exemplary system for making financial transfers according to one embodiment of the present invention. As illustrated here, the system 100 can include a money transfer facilitator 140 system such as the systems operated by Western Union or another money transfer facilitator service. The money transfer facilitator 140 can be communicatively coupled with a financial transfer network 155. Also communicatively coupled with the financial transfer network 155 can be one or more financial institutions 160 and 170. Generally speaking and as understood by one skilled in the art, the money transfer facilitator 140 may access a source account 165 of one financial institution 160 and/or a destination account 175 of the same or a different financial institution 170 to affect a transfer from and/or to the accounts 165 and 175 via the financial transfer network 155.

The money transfer facilitator system 140 can also include or execute a mobile application 145. As will be seen, the mobile application 145 of the money transfer facilitator can be adapted to support transaction involving one or more mobile devices. Generally speaking, the mobile application 145 can be adapted to identify the entities and/or accounts associated with a transaction and/or determine a destination for a payment of the transaction. For example, the entities and/or accounts can be identified based on a set of mobile subscriber data 150 maintained in a database or other repository. It should be noted that, while illustrated here as separate from the money transfer facilitator system 140, the mobile subscriber data 150 need not be separated from the money transfer facilitator system 140. Rather, the mobile subscriber data 150 can be either internal to or external from the money transfer facilitator system 140 depending upon the exact implementation.

The system can also include an agent 135 in communication with the money transfer facilitator 140. The agent 135 can comprise a retail outlet location and associated systems of the money transfer facilitator 140. Generally speaking, the agent 135 provides a channel by which entities can access the services of the money transfer facilitator 140. It should also be noted that, while not illustrated here for the sake of simplicity and clarity, the agent 135 and/or money transfer facilitator 140 can also provide other channels for accessing the services of the money transfer facilitator 140. For example, such channels can include but are not limited to a web site, a telephone service, a kiosk, an ATM or other channels. Generally speaking and as understood by one skilled in the art, via one or more such channels, a sender 105 can initiate a transaction to transfer money to a recipient 1 10. For example, a sender 105 can access the services of the money transfer facilitator 140 via a web site of the money transfer facilitator 140 and initiate a money transfer from a source account 165 owned by the sender 105. The recipient 110 of the payment may then, for example, pick up the payment from the agent's 135 retail location.

The system 100 can also include a mobile network 115, such as a cellular or other wireless network, communicatively coupled with the agent 135 and/or the money transfer facilitator 140. A mobile network operator system 120 can be communicatively coupled with the mobile network 115. As understood by one skilled in the art, the mobile network 115 and mobile network operator system 120 can support communication to and/or from mobile devices communicatively coupled therewith such as a mobile device associated with the sender 105 and/or a mobile device associated with the recipient 110. It should be noted that the names sender and recipient are used only to illustrate a particular entity's and/or device's function at a given time and are not intended to imply any limitations on the functions that can be performed by a given entity and/or device. That is, any given entity and/or device associated with that entity can alternately act as sender or recipient. Also, it should be understood that while only one mobile network 115 and mobile network operator 120 are illustrated here for the sake of simplicity and clarity, multiple mobile networks 115 and mobile network operators 120 may be present. In some cases, the mobile network and mobile network operator of the sender 105 may be different from the mobile network and mobile network operator of the recipient 110.

The mobile network operator system 120 can include and/or execute a mobile wallet application 120 or service. Generally speaking, the mobile wallet application 121 maintains mobile wallets 125 and 130 for one or more subscribers, such as the sender 105 and/or recipient 110 to the mobile wallet service 121. The mobile wallets 125 and 130 can each comprise information related to the device and accounts of the entity for which the mobile wallet is maintained. For example, the sender's mobile wallet 125 can maintain information identifying the sender's 105 mobile device, one or more accounts 165 associated with the mobile wallet, and other possible identifying information. Similarly, the recipient's mobile wallet 130 can maintain information identifying the recipient's 110 mobile device, one or more accounts 175 associated with the mobile wallet, and other possible identifying information.

According to one embodiment, the money transfer facilitator 140 can receive a request to initiate the money transfer transaction, for example a payment from the sender 105 to the recipient 110. The money transfer facilitator 140 can receive the request to initiate the money transfer transaction from the mobile wallet application 121 of a mobile network operator 120, from a web site of the money transfer facilitator 140, from the agent 135, from a telephone money transfer service of the money transfer facilitator 140, from a kiosk, from an ATM or from another channel. The request can include a unique identifier for the recipient 110 of the money transfer transaction. The unique identifier for the recipient 110 can comprise one or any combination of a phone number for a mobile device of the recipient, an email address for the recipient, an instant messaging identifier for the recipient, a preferred customer number for the recipient or other unique customer identifier issued by a money transfer facilitator 140 or its agent 135, the mobile network operator 120, a retailer, a bank, a service provider or any other party, account information (e.g., stored value account identifier, bank account number and/or ABA routing number), a tax number (e.g., Social Security Number or Taxpayer Identification Number), a drivers' license number, a state ID number, a student ID number or another unique identifier.

A destination for transferring funds for the money transfer transaction to the recipient 110 can be determined by the money transfer facilitator 140, agent 135, and/or mobile network operator 120 based at least in part on the unique identifier for the recipient 110. Determining the destination for transferring funds to the recipient 110 can comprise identifying mobile network operator 120 for the recipient 110 and determining whether the mobile network operator 120 for the recipient 110 has a relationship with the money transfer facilitator 140 supporting the money transfer transaction. If the mobile network operator 120 for the recipient 110 has a relationship with the money transfer facilitator 140, a determination can be made as to whether the recipient 110 is enrolled in a mobile wallet service 121 of the mobile network operator 120. If the recipient 110 is enrolled in the mobile wallet service 121 of the mobile network operator 120, the destination for transferring funds for the money transfer transaction to the recipient 110 can comprise an account 175 associated with the mobile wallet 130 of the recipient. If the recipient 110 is not enrolled in the mobile wallet service 121 of the mobile network operator 120, the destination for transferring funds for the money transfer transaction to the recipient 110 can comprise a retail outlet of the money transfer facilitator or other designated destination, e.g., the agent's 135 location. Additionally or alternatively, in response to determining the recipient 110 is not enrolled in the mobile wallet service 121 of the mobile network operator 120, a message can be sent to the recipient 110 inviting the recipient 110 to enroll in the mobile wallet service 121. If the recipient 110 enrolls in the mobile wallet service 121 of the mobile network operator 120, the destination for transferring funds for the money transfer transaction to the recipient 110 can comprise an account 175 associated with the mobile wallet 130 of the recipient 110. If the mobile network operator 121 for the recipient 110 does not have a relationship with the money transfer facilitator 140, the destination for transferring funds for the money transfer transaction to the recipient 110 can comprise a retail outlet of the money transfer facilitator or other designated destination e.g., the agent's 135 location.

Once the destination for transferring funds for the money transfer transaction to the recipient 110 has been determined, the funds can be transferred to the determined destination and the recipient 110 can be notified of availability of funds at the determined destination. Notification can be sent by a money transfer facilitator 140 to the recipient 110 and/or to any party associated with the designated destination (e.g., to a mobile network operator 120, a retailer, a bank, a service provider (e.g., payment service provider, auction service provider or Internet service provider) or any other party).

Such a system 100 allows a money transfer facilitator 140, using a unique customer identifier and internal and/or external mapping databases 150, to provide a structured settlement between unrelated entities such as the sending mobile wallet 125 and receiving mobile wallet 130, or between the sending cash retail location and receiving mobile wallet 130. It need not be a closed-loop system that allows mobile remittances only for consumers who are enrolled in the same mobile wallet system but rather allows entities that are unrelated to allow their enrolled consumers to send a mobile money transaction to a consumer either enrolled under another entity or not enrolled - in which case they are able to enroll in a mobile wallet service, pick up cash at a retail location of the money transfer facilitator or other cash retail outlet or designate a destination for receipt of the money transfer.

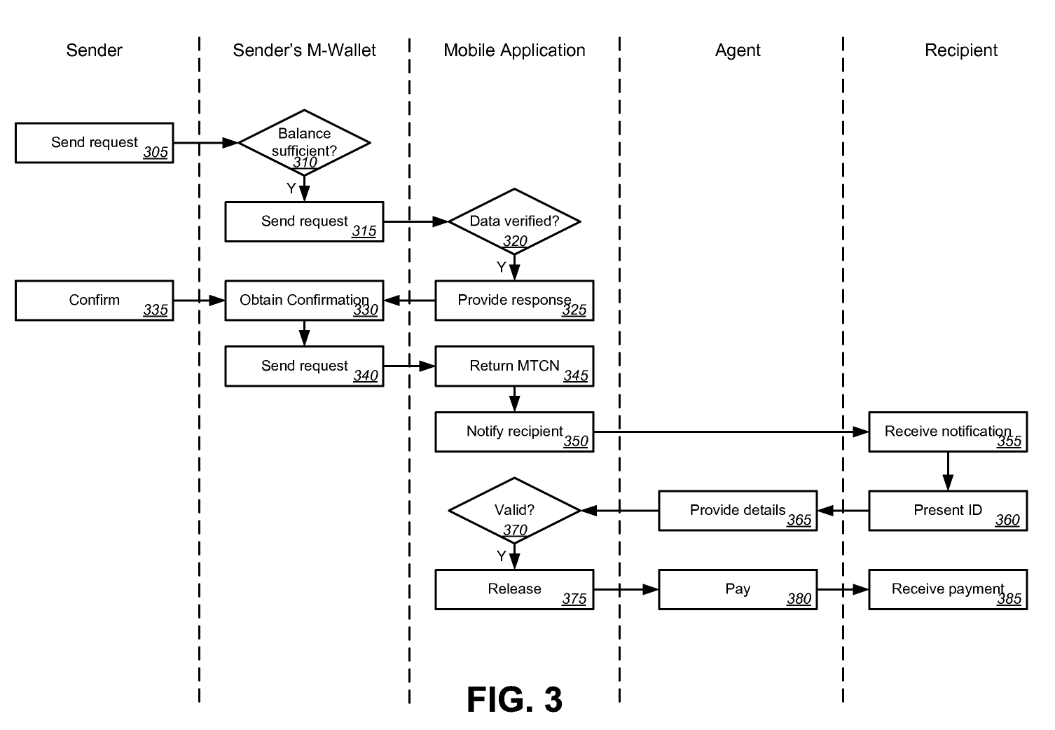

Stated another way, embodiments of the present invention provide for financial transfers utilizing a unique identifier to facility flexible payment delivery options for the transaction. For example, one option can comprise a “mobile-to-cash” option in which the user of a mobile device initiates a transaction paid from an account associated with a mobile wallet of that user to a recipient that can receive the payment in cash, for example from an agent of the money transfer facilitator. Another option can comprise a “cash-to-mobile” option in which an entity pays for and initiates a transaction in person, for example via an agent of the money transfer facilitator, and wherein the payment is delivered to an account associated with a mobile wallet of the recipient. Yet another option can comprise a “mobile-to-mobile” option in which the user of a mobile device initiates a transaction paid from an account associated with a mobile wallet of that user wherein the payment is delivered to an account associated with a mobile wallet of the recipient. These options can include variations such as an option to allow a user of a mobile device to enroll “on the fly.” That is, if a transaction involves a recipient is not currently enrolled in a mobile service that allows mobile delivery of payments, i.e., payment to an account associated with a mobile wallet, the recipient may be provided with a notice of availability of the payment and an opportunity to enroll in the service and receive the payment at that time. Each of these options will be described below in more detail with reference to FIGS. 3-7.

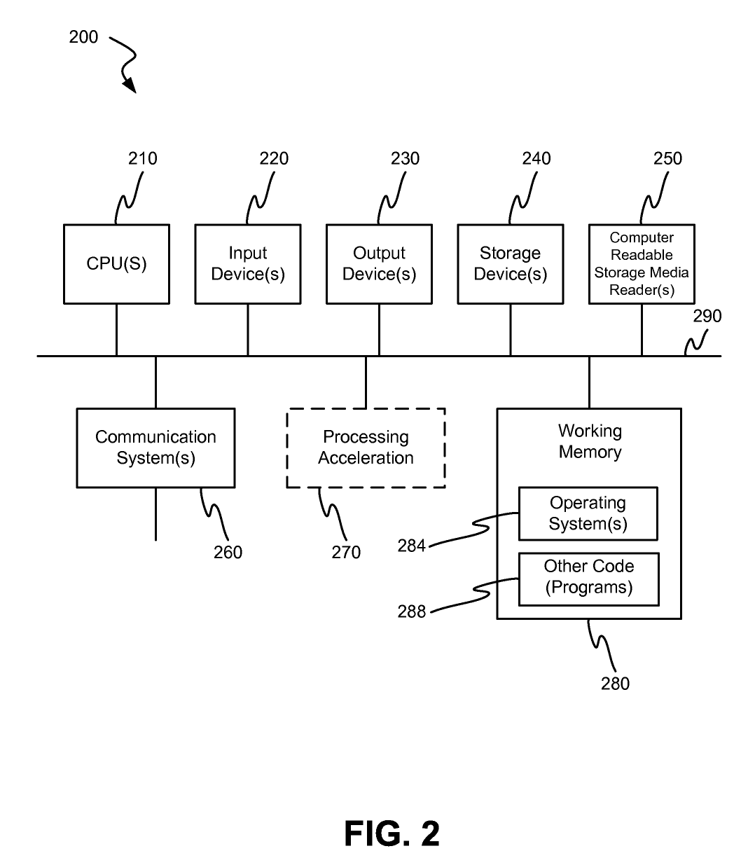

FIG. 2 is a block diagram illustrating an exemplary computer system upon which embodiments of the present invention may be implemented. This example illustrates a computer system 200 such as may be used, in whole, in part, or with various modifications, to provide the functions of the sender's mobile device, the receiver's mobile device, the agent 135 system, the money transfer facilitator system 140, the mobile network operator system 120, and/or other components of the invention such as those discussed above.

The computer system 200 is shown comprising hardware elements that may be electrically coupled via a bus 290. The hardware elements may include one or more central processing units 210, one or more input devices 220 (e.g., a mouse, a keyboard, etc.), and one or more output devices 230 (e.g., a display device, a printer, etc.). The computer system 200 may also include one or more storage device 240. By way of example, storage device(s) 240 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 250, a communications system 260 (e.g., a modem, a network card (wireless or wired), an infra-red communication device, Bluetooth™ device, cellular communication device, etc.), and working memory 280, which may include RAM and ROM devices as described above. In some embodiments, the computer system 200 may also include a processing acceleration unit 270, which can include a digital signal processor, a special-purpose processor and/or the like.

The computer-readable storage media reader 250 can further be connected to a computer-readable storage medium, together (and, optionally, in combination with storage device(s) 240) comprehensively representing remote, local, fixed, and/or removable storage devices plus storage media for temporarily and/or more permanently containing computer-readable information. The communications system 260 may permit data to be exchanged with a network, system, computer and/or other component described above.

The computer system 200 may also comprise software elements, shown as being currently located within a working memory 280, including an operating system 284 and/or other code 288. It should be appreciated that alternate embodiments of a computer system 200 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 200 may include code 288 for implementing any or all of the function of the various elements of the architecture as described herein. For example, software, stored on and/or executed by a computer system such as system 200, can provide the functions of the sending subscriber interface, the receiving subscriber interface, the agent server 125, the source transfer network 165, the primary transfer network 160, the destination transfer network 190, the communication network 115, and/or other components of the invention such as those discussed above.

As noted above, embodiments of the present invention provide for financial transfers utilizing a unique identifier to facility flexible payment delivery options for the transaction. For example, one option can comprise a “mobile-to-cash” option in which the user of a mobile device initiates a transaction paid from an account associated with a mobile wallet of that user to a recipient that can receive the payment in cash, for example from an agent of the money transfer facilitator. Another option can comprise a “cash-to-mobile” option in which an entity pays for and initiates a transaction in person, for example via an agent of the money transfer facilitator, and wherein the payment is delivered to an account associated with a mobile wallet of the recipient. Yet another option can comprise a “mobile-to-mobile” option in which the user of a mobile device initiates a transaction paid from an account associated with a mobile wallet of that user wherein the payment is delivered to an account associated with a mobile wallet of the recipient. These options can include variations such as an option to allow a user of a mobile device to enroll “on the fly.” That is, if a transaction involves a recipient is not currently enrolled in a mobile service that allows mobile delivery of payments, i.e., payment to an account associated with a mobile wallet, the recipient may be provided with a notice of availability of the payment and an opportunity to enroll in the service and receive the payment at that time. Each of these options will be described below in more detail with reference to FIGS. 3-7.

FIG. 3 illustrates an exemplary flow for a “mobile-to-cash” transaction according to one embodiment of the present invention. In this example, the process begins with a sender 105 initiating a money transfer by sending 305 a request to a mobile wallet application 121 of the sender's mobile network operator 120. The mobile wallet application 121 can check 310 a current balance of the account 165 associated with the sender's mobile wallet 125 and, if the funds in the account 165 associated with the sender's mobile wallet 125 are sufficient for the transfer, the mobile wallet application 121 can in turn send 315 a request to a mobile application 145 of the money transfer facilitator 140. This request can include, for example, information identifying the send, information identifying the recipient, transaction information, e.g., amount, etc. and/or other information. While FIG. 3 describes the process beginning with a sender 105 initiating a money transfer by sending a request to a mobile wallet application 121 of the sender's mobile network operator 120, it should be appreciated that a sender 105 can begin the process by initiating a money transfer through a money transfer facilitator 140 (or its agent 135), which then queries a mobile network operator 120 whether sufficient funds are available in the account 160 associated with the mobile wallet 125 of the sender.

The mobile application 145 of the money transfer facilitator 140, upon receiving the request, can perform a process to look up (e.g., a Mobile Station Integrated Service Digital Network (MSISDN), International Mobile Subscriber Identity (IMSI) and/or Temporary Mobile Subscriber Identity (TMSI)) for the sender 105 and/or recipient 110 and/or otherwise verify 320 the data provided by the mobile wallet application 121 in the request. The mobile application 145 of the money transfer facilitator 140 can then provide 325 a response to the request from the mobile wallet application 121. If the data of the request is verified by the mobile application 145 of the money transfer facilitator 140, the response may include information related to and/or describing fees, legal notices, etc. Alternatively or additionally, the look up can be performed by the mobile network operator 120.

The mobile wallet application 121, upon receiving the response from the mobile application 145 of the money transfer facilitator 140 can obtain 330 and 335 confirmation of the transaction from the sender 105. Upon confirmation 330 and 335, the mobile wallet application 121 can in turn send 340 a transfer request to the mobile application 145 of the money transfer facilitator 140.

Upon receipt of the transfer request, the mobile application 145 of the money transfer facilitator 140 can initiate a money transfer send process which returns 345 a transaction identifier (e.g., Money Transfer Control Number (MTCN)) to the mobile wallet application 121 indicating that the transaction is available for payout. Additionally, the mobile application 145 of the money transfer facilitator 140 can send 350 a notification of the transaction and the availability of funds to the recipient 110.

The recipient 110, after receiving 355 the notification, can present 360 an identification, the MSISDN, the MTCN, answer to a test question and/or other information to an agent 135 of the money transfer facilitator, e.g., at a retail outlet of the money transfer facilitator 140. The agent 135 of the money transfer facilitator 140 can in turn submit 365 this information and/or routing details for the transfer to the mobile application 145 of the money transfer facilitator 140. The mobile application 145 of the money transfer facilitator 145 can then perform a validation 370 of the data provided by the agent 135 and, if valid, perform a money transfer release process 375 to route the money transfer and/or instruct the agent 135 to pay 380 and 385 the transaction to the recipient 110.

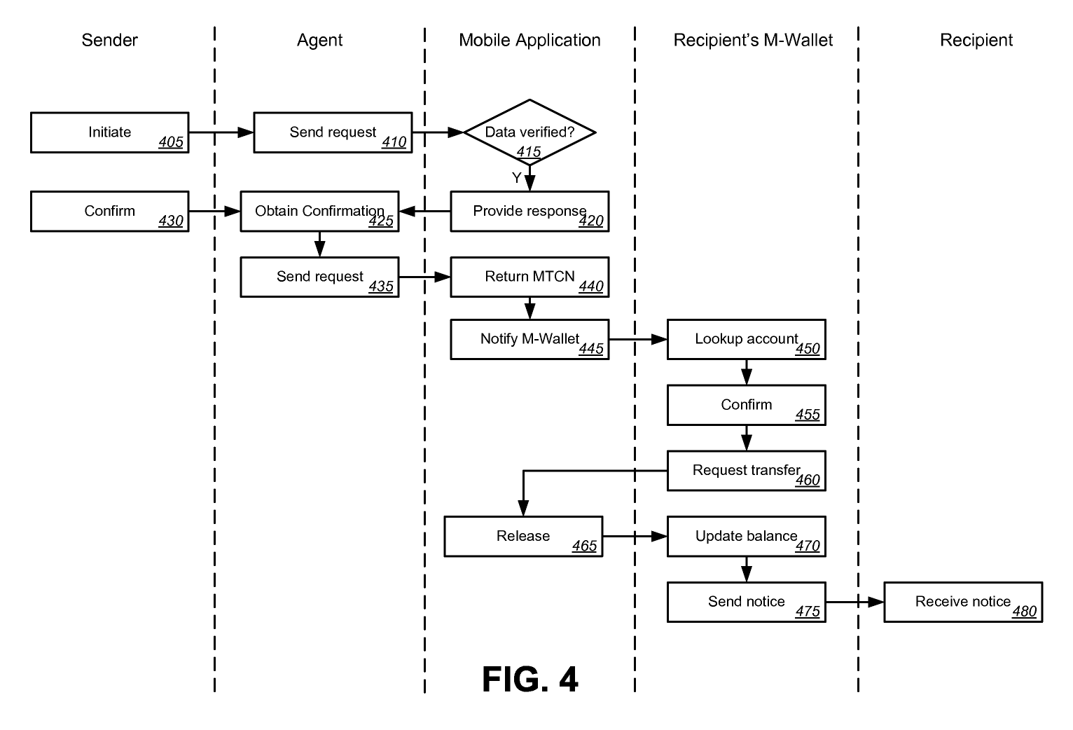

FIG. 4 illustrates an exemplary flow for a “cash-to-mobile” transaction according to one embodiment of the present invention. In this example, the process begins with a sender 105 initiating 405 a money transfer via an agent 135 of the money transfer facilitator 140, e.g., a retail outlet. That is, the sender 105 can pay cash to the agent 135 and provide an identifier for the recipient 110 of the transfer. For example, the process also could begin with a sender 105 initiating a money transfer via a website, telephone, kiosk, ATM, in-lane at a retailer or through any other channel and paying for the transfer and applicable fees through any available funding source (e.g., credit card or account, ATM or debit card or account, prepaid card or account, smart card, check, electronic check, travelers check, money order or through an Automated Clearing House). The money transfer facilitator 140 (or its agent 135) can in turn submit 410 a request to a money transfer facilitator 140 mobile application 145.

The money transfer facilitator 140 mobile application 145 can in turn perform a process to look up (e.g., an MSISDN, IMSI and/or TMSI) for the recipient 110 and/or otherwise verify 415 the data provided by the sender 105. The mobile application 145 of the money transfer facilitator 140 can then provide a response 420 to the request from the money transfer facilitator 140 or its agent 135. If the data of the request is verified by the mobile application 145 of the money transfer facilitator 140, the response may include information related to and/or describing fees, legal notices, etc. Alternatively or concurrently, the look up can be performed by the mobile network operator 120.

The agent 135 can in turn request confirmation 425 of the transaction from the sender 105. Upon confirmation 430 of the transaction by the sender 105, the agent 135 of the money transfer facilitator 140 can send 435 a transfer request to the mobile application 145 of the money transfer facilitator 140.

Upon receipt of the transfer request, the mobile application 145 of the money transfer facilitator 140 can initiate a money transfer send process which returns 440 an MTCN to the agent 135. Additionally, the mobile application 145 of the money transfer facilitator 140 can send 445 a notification of the transaction and the availability of funds to the mobile wallet 130 of the recipient 110 and/or to the mobile network operator 120.

The mobile wallet application 121, upon receiving the notification from the mobile application 145 of the money transfer facilitator 140, can execute a look-up 450 account process to determine an account 175 associated with the mobile wallet 130 into which the funds should be transferred. Once this account is identified, the mobile wallet 130 can send a message to the mobile application 145 of the money transfer facilitator 140 confirming 455 the recipient 110. Additionally, the mobile wallet 130 can send 460 a message to the mobile application 145 of the money transfer facilitator 140 to initiate the receipt, i.e., the transfer of funds to the identified account 175.

Upon receipt of the transfer request, the mobile application 145 of the money transfer facilitator 140 can perform a money transfer release process 465. The process 465 can perform a transfer of the funds to the identified account 175 of the recipient 110 and send a message to the mobile wallet application 121 indicating success or failure of the transfer. The mobile wallet application 121 can in turn update 470 a balance of the account, assuming a successful transfer, and notify 475 and 480 the recipient of the transfer.

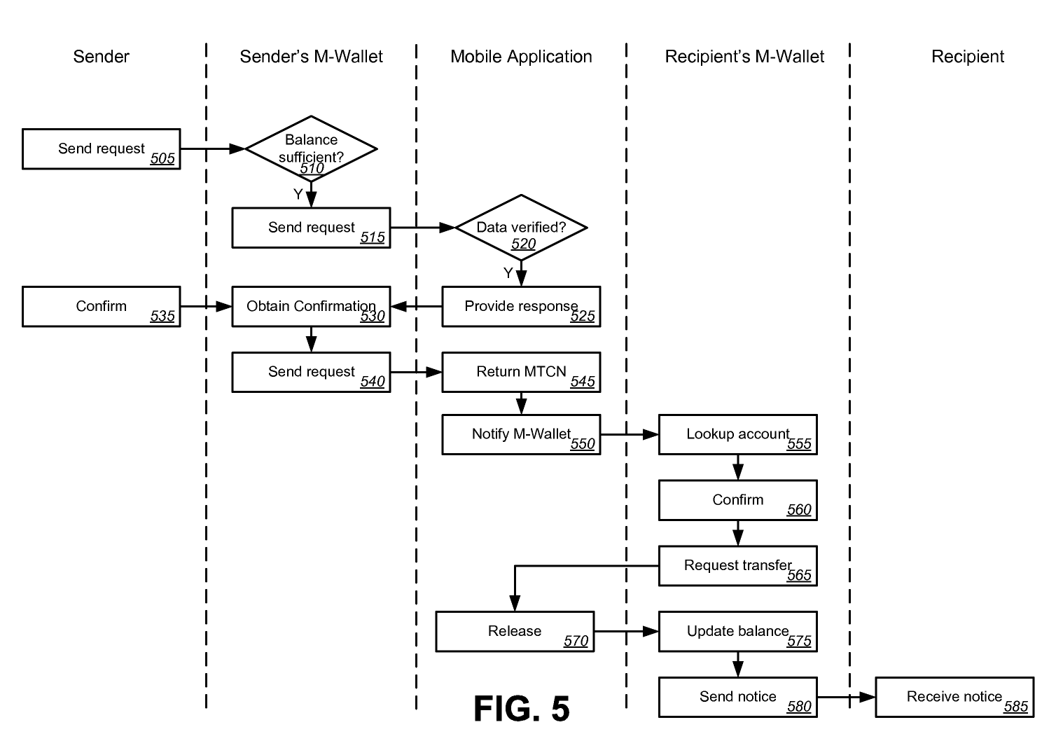

FIG. 5 illustrates an exemplary flow for a “mobile-to-mobile” transaction according to one embodiment of the present invention. In this example, the process begins with a sender 105 initiating a money transfer by sending 505 a request to a mobile wallet application 121 of the sender's mobile network operator 120. The mobile wallet application 121 of the sender 105 can check 510 a current balance of the account 165 associated with the sender's mobile wallet 125 and, if 510 the funds in the account 165 associated with the sender's mobile wallet 125 are sufficient for the transfer, the mobile wallet application 121 can in turn send 515 a request to a mobile application 145 of the money transfer facilitator 140. This request can include, for example, information identifying the sender 105, information identifying the recipient 110, transaction information, e.g., amount, etc. and/or other information.

The mobile application 145 of the money transfer facilitator 140, upon receiving the request, can perform a process to look up (e.g., via MSISDN, IMSI and/or TMSI) for the sender 105 and/or recipient 110 and/or otherwise verify 520 the data provided by the mobile wallet application 121 of the sender 105 in the request. The mobile application 145 of the money transfer facilitator 140 can then provide a response 525 to the request from the mobile wallet application 121 of the sender 110. If the data of the request is verified by the mobile application 145 of the money transfer facilitator 140, the response may include information related to and/or describing fees, legal notices, etc. Alternatively or additionally, the look up can be performed by the mobile network operator 120.

The mobile wallet application 121 of the sender 110, upon receiving the response from the mobile application 145 of the money transfer facilitator 140 can obtain confirmation 530 and 535 of the transaction from the sender 105. Upon confirmation 530 and 535, the mobile wallet application 121 of the sender 105 can in turn send 540 a transfer request to the mobile application 145 of the money transfer facilitator 140.

Upon receipt of the transfer request, the mobile application 145 of the money transfer facilitator 140 can initiate a money transfer send process which returns 545 a Money Transfer Control Number (MTCN) to the mobile wallet application 121 indicating that the transaction is available for payout. The mobile application 145 of the money transfer facilitator 140 can also send 550 a message to the mobile wallet 130 of the recipient 110 and/or to the mobile network operator 120 indicating availability of the funds for transfer.

The mobile wallet application 121 of the recipient 110, upon receiving the notification from the mobile application 145 of the money transfer facilitator 140, can execute a look-up account process 55 to determine an account 175 associated with the mobile wallet 130 into which the funds should be transferred. Once this account is identified, the mobile wallet 130 of the recipient 110 can send 560 a message to the mobile application 145 of the money transfer facilitator 140 confirming the recipient. Additionally, the mobile wallet 130 of the recipient 110 can send 565 a message to the mobile application 145 of the money transfer facilitator 140 to initiate the receipt, i.e., the transfer of funds to the identified account 175.

Upon receipt of the transfer request, the mobile application 145 of the money transfer facilitator 140 can perform a money transfer release process 570. The process 570 can perform a transfer of the funds to the identified account 175 of the recipient 110 and send a message to the mobile wallet application 121 of the recipient 110 indicating success or failure of the transfer. The mobile wallet application 121 of the recipient 110 can in turn update 575 a balance of the account, assuming a successful transfer, and notify 580 and 585 the recipient 110 of the transfer.

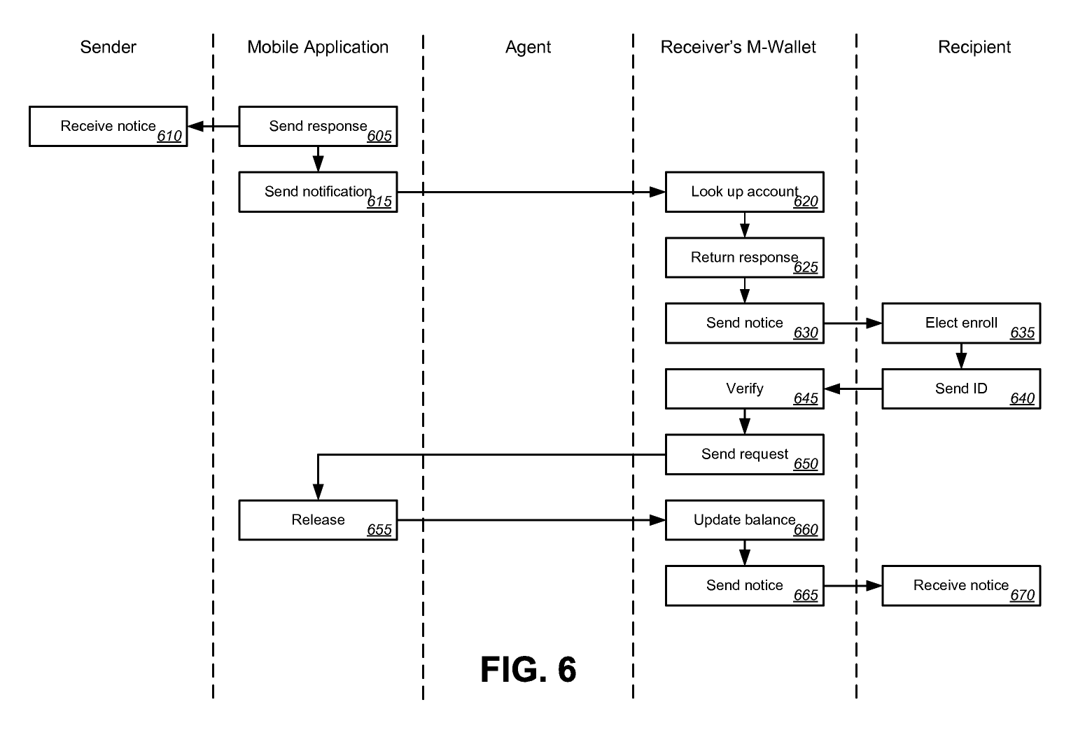

FIG. 6 illustrates an exemplary flow for a transaction in which the recipient enrolls “in-flight” according to one embodiment of the present invention. In this example, processing begins after the money transfer send process has been initiated by the mobile application 145 of the money transfer facilitator 140 as described in the examples above. At this point, the mobile application 145 of the money transfer facilitator 140 can send 605 and 610 a response message to the sender 105, either the agent 135 of the money transfer facilitator 140 or the mobile wallet 125 of the sender 105, indicating the MTCN and/or that the transaction is available for payout. Also, the mobile application 145 of the money transfer facilitator 140 can send 615 a message to the mobile wallet application 121 of the recipient's 110 mobile network operator 120 indicating availability of the funds for transfer.

Upon receipt of the message indicating availability of the funds for transfer, the mobile wallet application 121 of the recipient's 120 wireless network operator 120 can perform a look up process 620 to attempt to identify an account 175 associated with the recipient's 110 mobile wallet 130. However, if the recipient 110 does not have a mobile wallet, i.e., the recipient 110 does not subscribe to or enroll in that service, the mobile wallet application 121 of the recipient's mobile network operator 120 can return 625 a response to the mobile application 145 of the money transfer facilitator 140 indicating that the recipient 110 does not have an account/wallet. Additionally, the mobile wallet application 121 of the recipient's mobile network operator 120 and/or money transfer facilitator 140 can send 630 a message to the recipient 110, e.g., via the recipient's mobile device, notifying the recipient 110 of the availability of funds and inviting the recipient 110 to enroll in the mobile wallet service to receive the transfer.

The recipient 110 can then elect, for example, via the recipient's mobile device, to enroll in the service to receive the funds transfer, to pick up the funds at an agent 135 of the money transfer facilitator 140 or to designate a destination for receiving the money transfer. If the recipient elects to enroll 635, the recipient 110 can provide 640 some identifying information to the mobile wallet application 121. The mobile wallet application 121 can in turn perform a search or verification process 645. Upon successful completion of this process, the mobile wallet application 121 can send 650 a transfer request to the mobile application 145 of the money transfer facilitator 140 to complete the transfer.

Upon receipt of the transfer request, the mobile application 145 of the money transfer facilitator 140 can perform a money transfer release process 655. The process 655 can perform a transfer of the funds to the identified account 175 of the recipient 110 and send a message to the mobile wallet application 121 of the recipient 110 indicating success or failure of the transfer. The mobile wallet application 121 of the recipient 110 can in turn update 660 a balance of the account 175, assuming a successful transfer, and notify 665 and 670 the recipient 110 of the transfer. Alternatively, or in addition, the money transfer facilitator 140 can notify the recipient 110 of the transfer.

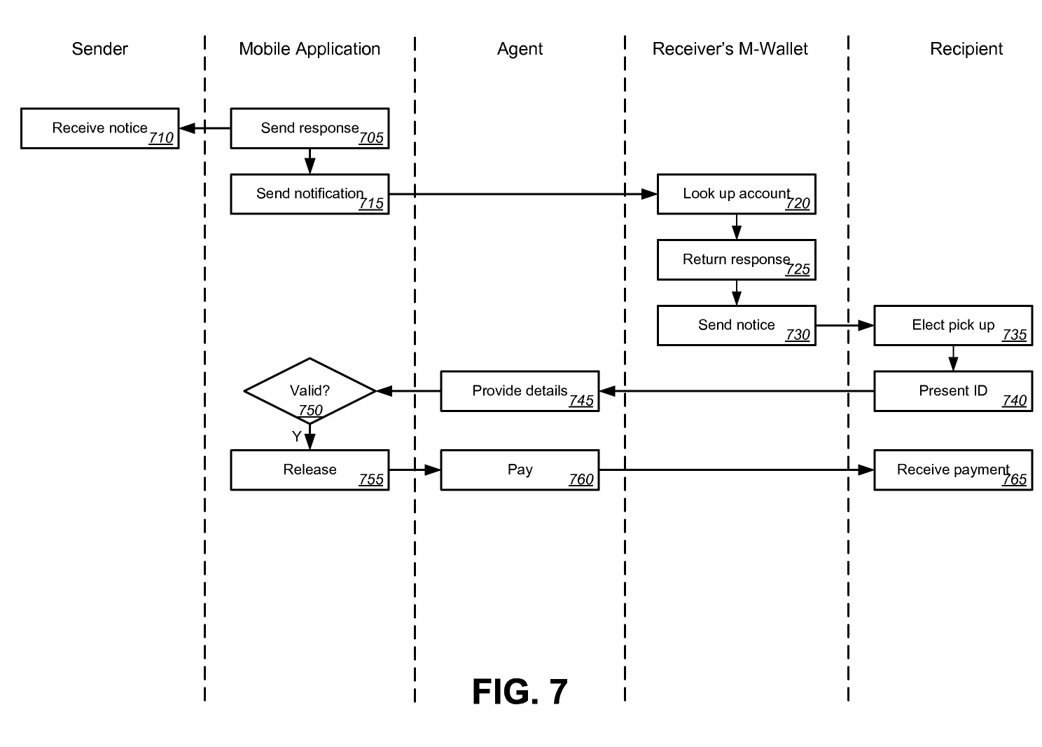

FIG. 7 illustrates an exemplary flow for a transaction in which the recipient elects a “cash pick-up” option according to one embodiment of the present invention. In this example, processing begins after the money transfer send process has been initiated by the mobile application 145 of the money transfer facilitator 140 as described in the examples above. At this point, the mobile application 145 of the money transfer facilitator 140 can send 705 and 710 a response message to the sender 105, either the agent 135 of the money transfer facilitator 140 or the mobile wallet 125 of the sender 105, indicating the MTCN and/or that the transaction is available for payout. Also, the mobile application 145 of the money transfer facilitator 140 can send 715 a message to the mobile wallet application 121 of the recipient's 110 mobile network operator 120 indicating availability of the funds for transfer.

Upon receipt of the message indicating availability of the funds for transfer, the mobile wallet application 121 of the recipient's mobile network operator 120 can perform a look up process 720 to attempt to identify an account 175 associated with the recipient's 110 mobile wallet 130. However, if the recipient 110 does not have a mobile wallet, i.e., the recipient 110 does not subscribe to or enroll in that service, the mobile wallet application 121 of the recipient's mobile network operator 120 can return 725 a response to the mobile application 145 of the money transfer facilitator 140 indicating that the recipient 110 does not have an account/wallet. Additionally, the mobile wallet application 121 of the recipient's mobile network operator 120 and/or the money transfer facilitator 140 can send 730 a message to the recipient 110, e.g., via the recipient's mobile device, notifying the recipient 110 of the availability of funds and inviting the recipient 110 to enroll in the mobile wallet service to receive the transfer or otherwise designate a destination for receiving the money transfer.

The recipient 110 can then elect, for example, via the recipient's mobile device, to enroll in the service to receive the funds transfer, to pick up the funds at an agent 135 of the money transfer facilitator 140 or designate a destination for receiving the money transfer. If the recipient 110 elects 735 to pick up the funds from an agent 135 of the money transfer facilitator 140, the recipient 110 can present 740 an identification, the MSISDN, IMSI, TMSI, the MTCN, provide an answer to a test question and/or other information to the agent 135 of the money transfer facilitator 140, e.g., at a retail outlet of the money transfer facilitator 140. The agent 135 of the money transfer facilitator 140 can in turn submit 745 this information and/or routing details for the transfer to the mobile application 145 of the money transfer facilitator 140. The mobile application 145 of the money transfer facilitator 140 can then perform a validation 750 of the data provided by the agent 135 and, if valid, perform a money transfer release process 755 to route the money transfer and/or instruct the agent 135 to pay 760 and 765 the transaction to the recipient.

It should be understood that, while described herein with reference to mobile devices, embodiments of the present invention are not limit to use with any type of device, wired or wireless, or any channel of communication. Rather, the sender, the recipient, or both can use any of a variety of channels to initiate a transfer, receive notification of the transfer, and/or direct funds in the transfer. For example, the sender and/or recipient can be a customer of a bank, a payment service (like PayPal), a local and/or long distance telephone service, a cable or satellite television service. In other examples, the sender and/or recipient may hold a loyalty card issued by a money transfer facilitator 140 (e.g., Western Union Gold Card holder who receives money is notified of transfer and can designate destination for receiving the transfer) or by a third party (e.g., receiver has loyalty number (represented by account number, telephone number, bar code, etc.) issued by a retailer such as a grocery store and sender can use that loyalty number to send money to an account designated by the recipient for recipient's use in making purchases at retailer. In yet other examples the sender and/or recipient can be registered with an action site like eBay. In any of these examples, transfers can be initiated by a sender through a channel appropriate to that sender, the transfer can be handled and directed by a money transfer facilitator 140, network operator, service provider, third-party, and/or other entities as appropriate for that channel, notification can be directed to the recipient through a channel appropriate to that recipient, and funds can be directed to a destination as determined as described above.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of supporting a money transfer transaction, the method comprising:
receiving a request to initiate the money transfer transaction, the request including a unique identifier for a recipient of the money transfer transaction;
determining a destination for transferring funds for the money transfer transaction to the recipient based at least in part on the unique identifier for the recipient;
transferring the funds for the money transfer transaction to the determined destination; and
notifying the recipient of availability of funds at the determined destination.

2. The method of claim 1, wherein receiving the request to initiate the money transfer transaction comprises receiving the request from a mobile wallet application.

3. The method of claim 1, wherein receiving the request to initiate the money transfer transaction comprises receiving the request from a web site of a money transfer facilitator.

4. The method of claim 1, wherein receiving the request to initiate the money transfer transaction comprises receiving the request from a retail agent location of a money transfer facilitator.

5. The method of claim 1, wherein receiving the request to initiate the money transfer transaction comprises receiving the request from a telephone money transfer service of a money transfer facilitator.

6. The method of claim 1, wherein the unique identifier for the recipient of the money transfer transaction comprises a phone number for a mobile device of the recipient.

7. The method of claim 1, wherein the unique identifier for the recipient of the money transfer transaction comprises an email address for the recipient.

8. The method of claim 1, wherein the unique identifier for the recipient of the money transfer transaction comprises an instant messaging identifier for the recipient.

9. The method of claim 1, wherein the unique identifier for the recipient of the money transfer transaction comprises a preferred customer number for the recipient.

10. The method of claim 1, wherein determining the destination for transferring funds to the recipient comprises:
determining a mobile network operator for the recipient; and
determining whether the mobile network operator for the recipient has a relationship with a money transfer facilitator supporting the money transfer transaction.

11. The method of claim 10, further comprising in response to determining the mobile network operator for the recipient has a relationship with the money transfer facilitator, determining whether the recipient is enrolled in a mobile wallet service of the mobile network operator.

12. The method of claim 11, wherein the destination for transferring funds for the money transfer transaction to the recipient comprises an account associated with the mobile wallet service if the recipient is enrolled in the mobile wallet service of the mobile network operator.

13. The method of claim 11, wherein the destination for transferring funds for the money transfer transaction to the recipient comprises a destination designate by the recipient if the recipient is not enrolled in the mobile wallet service of the mobile network operator.

14. The method of claim 11, further comprising in response to determining the recipient is not enrolled in the mobile wallet service of the mobile network operator, sending a message to the recipient inviting the recipient to enroll in the mobile wallet service.

15. The method of claim 14, wherein the destination for transferring funds for the money transfer transaction to the recipient comprises an account associated with the mobile wallet service if the recipient enrolls in the mobile wallet service of the mobile network operator.

16. The method of claim 10, wherein the destination for transferring funds for the money transfer transaction to the recipient comprises a destination designated by the recipient if the mobile network operator for the recipient does not have a relationship with the money transfer facilitator.

17. A system comprising:
a mobile communications network; and
a money transfer facilitator system communicatively coupled with the mobile communications network, the money transfer facilitator system adapted to receive a request to initiate the money transfer transaction, the request including a unique identifier for a recipient of the money transfer transaction, determine a destination for transferring funds for the money transfer transaction to the recipient based at least in part on the unique identifier for the recipient, affect a transfer of the funds for the money transfer transaction to the determined destination, and notify the recipient of availability of funds at the determined destination.

18. The system of claim 17, further comprising a mobile network operator system communicatively coupled with the mobile communications network, wherein the money transfer money transfer facilitator, in determining the destination for transferring funds to the recipient further determines whether the mobile network operator has a relationship with the money transfer facilitator.

19. The system of claim 18, wherein the mobile network operator system is further adapted to determine whether the recipient is enrolled in a mobile wallet service of the mobile network operator system.

20. The system of claim 19, wherein the destination for transferring funds for the money transfer transaction to the recipient comprises an account associated with the mobile wallet service if the recipient is enrolled in the mobile wallet service of the mobile network operator.

21. The system of claim 19, wherein the destination for transferring funds for the money transfer transaction to the recipient comprises a destination designate by the recipient if the recipient is not enrolled in the mobile wallet service of the mobile network operator.

22. The system of claim 19, wherein in response to determining the recipient is not enrolled in the mobile wallet service of the mobile network operator, the mobile network operator system is adapted to send a message to the recipient inviting the recipient to enroll in the mobile wallet service.

23. The system of claim 22, wherein the destination for transferring funds for the money transfer transaction to the recipient comprises an account associated with the mobile wallet service if the recipient enrolls in the mobile wallet service of the mobile network operator.

24. The system of claim 18, wherein the destination for transferring funds for the money transfer transaction to the recipient comprises a destination designated by the recipient if the mobile network operator for the recipient does not have a relationship with the money transfer facilitator.

25. A machine-readable medium having stored thereon a series of instructions which, when executed by a processor, causes the processor to support a money transfer transaction by:
receiving a request to initiate the money transfer transaction, the request including a unique identifier for a recipient of the money transfer transaction;
determining a destination for transferring funds for the money transfer transaction to the recipient based at least in part on the unique identifier for the recipient;
transferring the funds for the money transfer transaction to the determined destination; and
notifying the recipient of availability of funds at the determined destination.

26. The machine-readable medium of claim 25, wherein determining the destination for transferring funds to the recipient comprises:
determining a mobile network operator for the recipient; and
determining whether the mobile network operator for the recipient has a relationship with a money transfer facilitator supporting the money transfer transaction.

27. The machine-readable medium of claim 26, further comprising in response to determining the mobile network operator for the recipient has a relationship with the money transfer facilitator, determining whether the recipient is enrolled in a mobile wallet service of the mobile network operator.

28. The machine-readable medium of claim 27, wherein the destination for transferring funds for the money transfer transaction to the recipient comprises an account associated with the mobile wallet service if the recipient is enrolled in the mobile wallet service of the mobile network operator.

29. The machine-readable medium of claim 27, wherein the destination for transferring funds for the money transfer transaction to the recipient comprises a destination designate by the recipient if the recipient is not enrolled in the mobile wallet service of the mobile network operator.

30. The machine-readable medium of claim 27, further comprising in response to determining the recipient is not enrolled in the mobile wallet service of the mobile network operator, sending a message to the recipient inviting the recipient to enroll in the mobile wallet service.

31. The machine-readable medium of claim 30, wherein the destination for transferring funds for the money transfer transaction to the recipient comprises an account associated with the mobile wallet service if the recipient enrolls in the mobile wallet service of the mobile network operator.

32. The machine-readable medium of claim 26, wherein the destination for transferring funds for the money transfer transaction to the recipient comprises a destination designated by the recipient if the mobile network operator for the recipient does not have a relationship with the money transfer facilitator.
